(19) United States
(12) Patent Application Publication
(10) Pub. No.: US 2026/0290302 A1
(43) Pub. Date: Sep. 24, 2026

(54) ACTIVE NOISE CONTROL DEVICE

(71) Applicant: HONDA MOTOR CO., LTD., Tokyo (JP)

(72) Inventor: Kosuke SAKAMOTO, Saitama (JP)

(21) Appl. No.: 19/550,851

(22) Filed: Feb. 26, 2026

(30) Foreign Application Priority Data
Mar. 19, 2025 (JP) 2025-045705

(51) Int. Cl. G10K 11/178

(52) U.S. Cl. CPC G10K 11/17854; G10K 11/17879; G10K 2210/1282; G10K 2210/3012; G10K 2210/3028

(57) ABSTRACT

An active noise control device for controlling output of a canceling sound to cancel noise includes: a control signal generator configured to generate a control signal based on an input signal; and a frequency converter configured to convert a sampling frequency of the control signal to generate an output signal of the canceling sound. The frequency converter is configured to: generate a first upsampled signal by increasing the sampling frequency of the control signal; generate a correction signal by correcting the first upsampled signal based on a predicted value of the first upsampled signal; and generate the output signal of the canceling sound by performing a low-pass filtering process on the correction signal or a signal based thereon.

### TECHNICAL FIELD

The present invention relates to an active noise control device.

### BACKGROUND ART

Conventionally, an active noise control device that controls output of a canceling sound to cancel noise is known. For example, the active noise control device includes a control signal generator that generates a control signal based on an input signal, and a frequency converter that converts a sampling frequency of the control signal.

JP2010-288246A discloses a technique for converting a sampling frequency of an input signal (differential code), in which the sampling frequency of the input signal is increased, and then noise in the input signal is removed by a low-pass filtering process.

As described above, increasing the sampling frequency of the input signal reduces the smoothness (waveform smoothness) of the input signal. When the low-pass filtering process is performed on the input signal with reduced smoothness, the amount of calculation required for the low-pass filtering process increases, and a delay amount (delay time) of an output signal relative to the input signal increases. If such a technique with a large delay amount is applied to the active noise control device, the responsiveness of the canceling sound to the noise may decrease, resulting in a decrease in the noise reduction performance.

### SUMMARY OF THE INVENTION

In view of the above background, an object of the present invention is to provide an active noise control device that can simultaneously suppress noise and delay when the sampling frequency of the control signal is converted.

To achieve such an object, one aspect of the present invention provides an active noise control device for controlling output of a canceling sound to cancel noise, the active noise control device comprising: a control signal generator configured to generate a control signal based on an input signal; and a frequency converter configured to convert a sampling frequency of the control signal to generate an output signal of the canceling sound. The frequency converter is configured to: generate a first upsampled signal by increasing the sampling frequency of the control signal; generate a correction signal by correcting the first upsampled signal based on a predicted value of the first upsampled signal; and generate the output signal of the canceling sound by performing a low-pass filtering process on the correction signal or a signal based thereon.

Thus, according to the above aspects, it is possible to provide the active noise control device that can simultaneously suppress noise and delay when the sampling frequency of the control signal is converted.

### BRIEF DESCRIPTION OF THE DRAWING(S)

FIG. 1 is a schematic diagram showing a vehicle to which an active noise control device according to an embodiment of the present invention is applied;

FIG. 2 is a block diagram showing the active noise control device according to the embodiment;

FIG. 3 is a waveform diagram showing a time variation of an amplitude of a correction signal;

FIG. 4 is a waveform diagram showing a time variation of an amplitude of an uncorrected signal;

FIG. 5 is a waveform diagram showing a time variation of an amplitude of a second upsampled signal and an output signal;

FIG. 6 is a waveform diagram showing a relationship between frequency and an amount of noise reduction;

FIG. 7A is an explanatory diagram showing a flow of a sample-based process;

FIG. 7B is an explanatory diagram showing a flow of a frame-based process; and

FIG. 8 is a block diagram showing an active noise control device according to another embodiment.

### DETAILED DESCRIPTION OF THE INVENTION

In the following, an active noise control device 1 (hereinafter abbreviated as the “noise control device 1”) according to an embodiment of the present invention will be described with reference to the drawings. In the specification, the symbol “\hat{ }” (hat) appended to a reference numeral indicates an identified value or an estimated value. In the drawings, the symbol “\hat{ }” is arranged above the reference numeral, whereas in the description, the symbol “\hat{ }” is arranged after the reference numeral.

### Vehicle 3

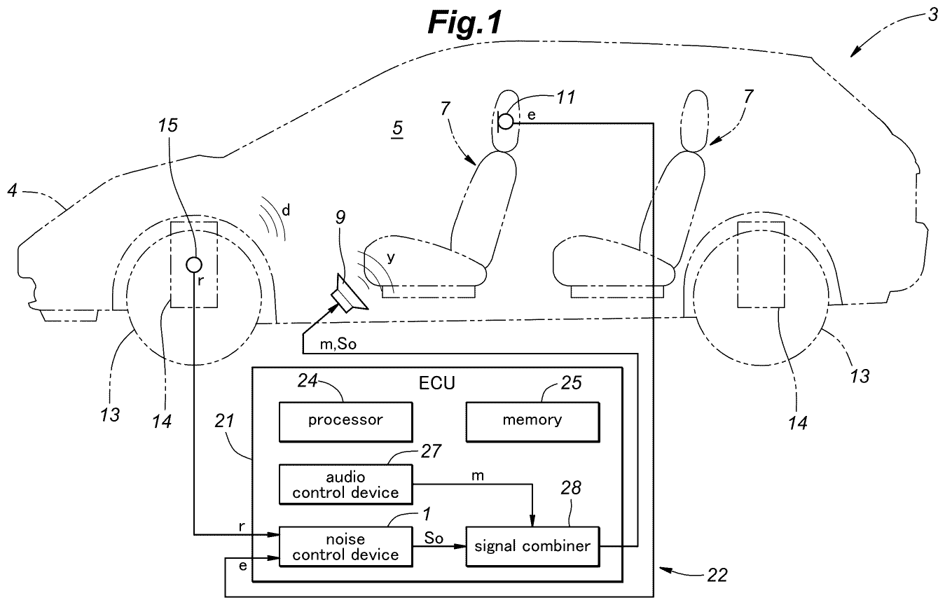

FIG. 1 is a schematic diagram showing a vehicle 3 to which the noise control device 1 is applied. The vehicle 3 includes a vehicle body 4 that defines the exterior of the vehicle 3. A vehicle cabin 5 is formed inside the vehicle body 4. The vehicle cabin 5 is provided with a plurality of occupant seats 7.

The vehicle cabin 5 is provided with a plurality of speakers 9 (only one of the speakers 9 is shown in FIG. 1). The plurality of speakers 9 is an example of a canceling sound output device. Each speaker 9 reproduces audio content (music, radio, voice guidance, and the like) and outputs a canceling sound y that is in opposite phase to noise d. The canceling sound y output from the speaker 9 interferes with the noise d, so that the canceling sound y and the noise d cancel each other out, thereby reducing the noise d. For example, the speaker 9 is installed at a location other than the occupant seat 7 in the vehicle cabin 5. In another embodiment, the speaker 9 may be installed on the occupant seat 7.

The vehicle cabin 5 is provided with a plurality of error microphones 11 (only one of the error microphones 11 is shown in FIG. 1). Each error microphone 11 generates an error signal e based on the noise d and the canceling sound y. For example, the error microphone 11 is installed on the occupant seat 7. In another embodiment, the error microphone 11 may be installed at a location other than the occupant seat 7 in the vehicle cabin 5.

A plurality of wheels 13 is arranged below the vehicle body 4. A suspension 14 is arranged between the vehicle body 4 and each wheel 13. The suspension 14 is provided with an acceleration sensor 15. The acceleration sensor 15 detects the acceleration of the suspension 14 according to the noise d, and generates a reference signal r according to the acceleration of the suspension 14. In another embodiment, the acceleration sensor 15 may be arranged at a location other than the suspension 14 of the vehicle 3. For example, the acceleration sensor 15 may be attached to a framework of the vehicle body 4.

### ECU 21

With reference to FIG. 1, the vehicle 3 is provided with an integrated electronic control unit (ECU) 21. The ECU 21, together with the speaker 9, the error microphone 11, and the acceleration sensor 15, constitutes an active noise reduction system 22.

The ECU 21 includes a processor 24, such as a CPU or MPU, and a memory 25, such as a ROM or RAM. The processor 24 executes the programs stored in the memory 25, causing the plurality of functional units of the ECU 21 to perform their functions. The ECU 21 is equipped with a plurality of functional units including an audio control device 27, the noise control device 1, and a signal combiner 28.

The audio control device 27 controls the reproduction of audio content (music, radio, voice guidance, and the like) by the speaker 9. The audio control device 27 generates the audio signal m corresponding to the audio content, and outputs the generated audio signal m to the signal combiner 28.

The noise control device 1 controls the output of the canceling sound y by the speaker 9. The noise control device 1 generates the output signal So of the canceling sound y (hereinafter simply referred to as the “output signal So”) based on the error signal e and the reference signal r, and outputs the generated output signal So to the signal combiner 28. The noise control device 1 will be described in detail later.

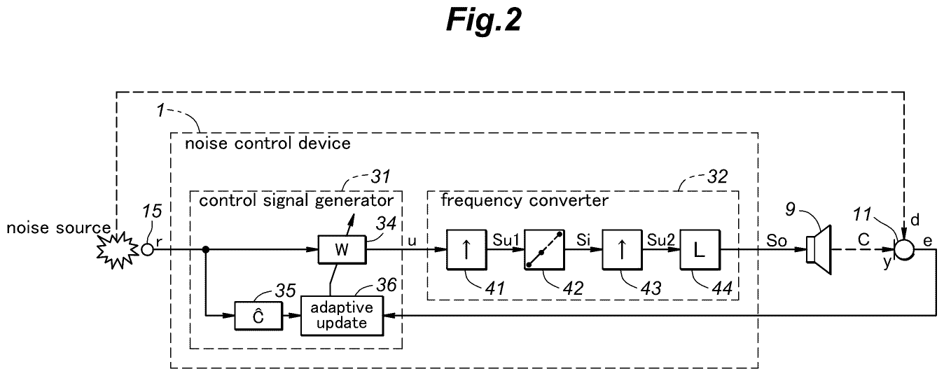

The signal combiner 28 combines the audio signal m and the output signal So, and outputs the combined audio signal m and the output signal So to the speaker 9. In response, the speaker 9 reproduces the audio content corresponding to the audio signal m, and outputs the canceling sound y corresponding to the output signal So. It should be noted that the signal combiner 28 is omitted in FIG. 2.

### Noise Control Device 1

With reference to FIG. 2, the noise control device 1 includes a control signal generator 31 that generates a control signal u based on the reference signal r and the error signal e (both signals are examples of the input signal), and a frequency converter 32 that converts the sampling frequency of the control signal u.

### Control Signal Generator 31

The control signal generator 31 of the noise control device 1 includes a control filter unit 34, a reference signal correction unit 35, and a control update unit 36.

The control filter unit 34 is constituted by a control filter W. For example, the control filter W is constituted by a finite impulse response (FIR) filter or a single frequency adaptive notch (SAN) filter. The control filter unit 34 generates the control signal u by filtering the reference signal r using the control filter W. The control filter unit 34 outputs the generated control signal u to the frequency converter 32.

The reference signal correction unit 35 is constituted by the secondary path filter C\hat{ }. The secondary path filter C\hat{ } is a filter that represents an estimated value of the transfer function C of the secondary path from the speaker 9 to the error microphone 11. For example, the secondary path filter C\hat{ } is constituted by the FIR filter or the SAN filter. The reference signal correction unit 35 corrects the reference signal r by filtering the reference signal r using the secondary path filter C\hat{ }. The reference signal correction unit 35 outputs the corrected reference signal r to the control update unit 36.

The control update unit 36 adaptively updates the control filter W using an adaptive algorithm such as the least mean square (LMS) algorithm. More specifically, the control update unit 36 adaptively updates the control filter W so that the error signal e output from the error microphone 11 is minimized.

### Frequency Converter 3

The frequency converter 32 of the noise control device 1 includes a first upsampling unit 41, a correction signal generation unit 42, a second upsampling unit 43, and a filtering processing unit 44.

The first upsampling unit 41 generates the first upsampled signal Su1 by increasing the sampling frequency of the control signal u output from the control signal generator 31. For example, the first upsampling unit 41 increases the sampling frequency of the control signal u by performing integer-multiple sampling-frequency conversion on the control signal u. The first upsampling unit 41 outputs the generated first upsampled signal Su1 to the correction signal generation unit 42.

The correction signal generation unit 42 generates the correction signal Si by correcting the first upsampled signal Su1 based on the predicted value of the first upsampled signal Su1. The process of generating the correction signal Si by the correction signal generation unit 42 will be described in detail later. The correction signal generation unit 42 outputs the generated correction signal Si to the second upsampling unit 43.

The second upsampling unit 43 generates the second upsampled signal Su2 by increasing the sampling frequency of the correction signal Si. For example, the second upsampling unit 43 increases the sampling frequency of the correction signal Si by performing integer-multiple sampling-frequency conversion on the correction signal Si. The increase ratio of the sampling frequency of the second upsampled signal Su2 relative to the sampling frequency of the correction signal Si is higher than the increase ratio of the sampling frequency of the first upsampled signal Su1 relative to the sampling frequency of the control signal u. The second upsampling unit 43 outputs the generated second upsampled signal Su2 to the filtering processing unit 44.

The filtering processing unit 44 is constituted by a low-pass filter L. The filtering processing unit 44 generates the output signal So by performing a low-pass filtering process on the second upsampled signal Su2 (an example of the signal based on the correction signal Si). Accordingly, the low-pass filtering process is performed on the second upsampled signal Su2, thereby reducing aliasing noise included in the second upsampled signal Su2.

### Generation Process of the Correction Signal Si

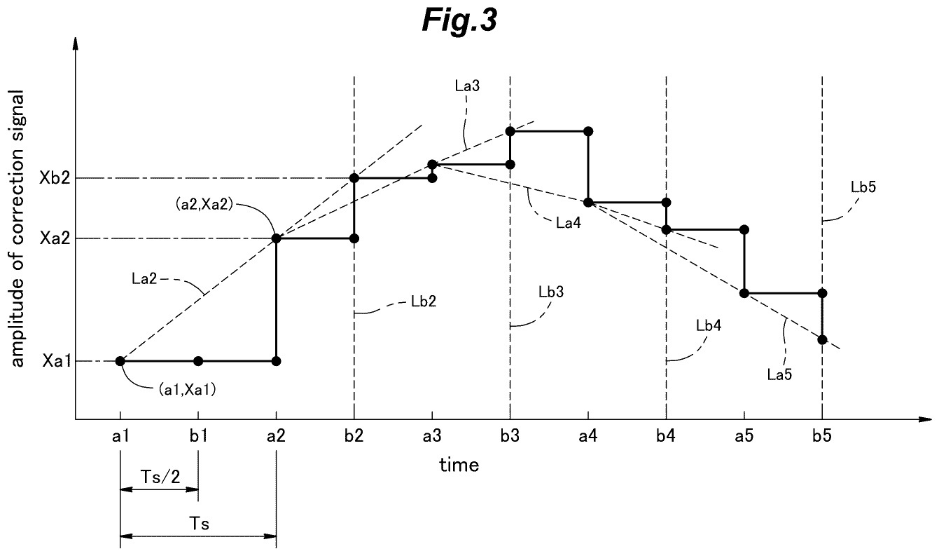

FIG. 3 is a waveform diagram showing the time variation of the amplitude of the correction signal Si. The time an (n=1, 2, 3, . . . ) in FIG. 3 indicates the time instant at each fundamental period Ts (hereinafter referred to as the “fundamental-period time an”). In an orthogonal coordinate system using time and the amplitude of the signal as two coordinate axes (hereinafter referred to as the “time-amplitude coordinate system”), the coordinates of a point indicating the amplitude Xan of the signal at a certain fundamental-period time an are expressed as (an, Xan). The time bn (n=1, 2, 3, . . . ) in FIG. 3 indicates the t ime instant when a half period Ts/2 has elapsed from the fundamental-period time an (hereinafter referred to as the “half-period time bn”). In the time-amplitude coordinate system, the coordinates of a point indicating the amplitude Xbn of the signal at a certain half-period time bn are expressed as (bn, Xbn).

The first upsampling unit 41 generates the first upsampled signal Su1 for each fundamental period Ts and outputs the generated first upsampled signal Su1 to the correction signal generation unit 42. When the first upsampled signal Su1, whose amplitude is Xa1, is input to the correction signal generation unit 42 at the fundamental-period time a1, the correction signal generation unit 42 sets the amplitude of the correction signal Si to Xa1. Between the fundamental-period time a1 and the fundamental-period time a2, the correction signal generation unit 42 holds the amplitude of the correction signal Si at Xa1 by a sample-and-hold process.

When the first upsampled signal Su1 with the amplitude Xa2 is input at the fundamental-period time a2, the correction signal generation unit 42 switches the amplitude of the correction signal Si from Xa1 to Xa2. Further, the correction signal generation unit 42 obtains a predicted value of the amplitude of the first upsampled signal Su1 at the half-period time b2, based on the time variation of the amplitude Xa2 of the first upsampled signal Su1 at the fundamental-period time a2 relative to the amplitude Xa1 of the first upsampled signal Su1 at the fundamental-period time a1.

More specifically, the correction signal generation unit 42 generates, in the time-amplitude coordinate system, a straight line (hereinafter referred to as a “projected line La2”) that passes through the point (a1, Xa1) indicating the amplitude Xa1 of the first upsampled signal Su1 at the fundamental-period time a1 and the point (a2, Xa2) indicating the amplitude Xa2 of the first upsampled signal Su1 at the fundamental-period time a2. That is, the correction signal generation unit 42 generates the projected line La2 by linearly approximating the time variation of the amplitude of the first upsampled signal Su1 using the first-order Taylor series expansion. The correction signal generation unit 42 obtains the amplitude Xb2 at the intersection of the projected line La2 and a straight line Lb2 indicating the half-period time b2 as a predicted value of the amplitude of the first upsampled signal Su1 at the half-period time b2. As described above, the correction signal generation unit 42 calculates the predicted value of the first upsampled signal Su1 by an extrapolation process (extrapolation operation) based on the amplitudes Xa1 and Xa2 of the first upsampled signal Su1 at the fundamental-period times a1 and a2 (i.e., the past values of the first upsampled signal Su1).

Between the fundamental-period time a2 and the half-period time b2, the correction signal generation unit 42 holds the amplitude of the correction signal Si at Xa2 by the sample-and-hold process. At the half-period time b2, the correction signal generation unit 42 switches the amplitude of the correction signal Si from Xa2 to Xb2.

From the fundamental-period time a3 onward, the correction signal generation unit 42 repeats the same process as above. That is, the correction signal generation unit 42 obtains a predicted value of the amplitude of the first upsampled signal Su1 at the next half-period time bn (the intermediate time between the current fundamental-period time an and the next fundamental-period time a(n+1)) based on the time variation of the amplitude Xan of the first upsampled signal Su1 at the current fundamental-period time an relative to the amplitude Xa(n−1) of the first upsampled signal Su1 at the previous fundamental-period time a(n−1).

More specifically, the correction signal generation unit 42 generates, in the time-amplitude coordinate system, the projected line Lan that passes through the point (a(n−1), Xa(n−1)) indicating the amplitude Xa(n−1) of the first upsampled signal Su1 at the previous fundamental-period time a(n−1) and the point (an, Xan) indicating the amplitude Xan of the first upsampled signal Su1 at the current fundamental-period time an. That is, the correction signal generation unit 42 generates the projected line Lan by linearly approximating the time variation of the amplitude of the first upsampled signal Su1 using the first-order Taylor series expansion. The correction signal generation unit 42 obtains the amplitude Xbn at the intersection of the projected line Lan and a straight line Lbn indicating the half-period time bn as a predicted value of the amplitude of the first upsampled signal Su1 at the next half-period time bn.

Between the fundamental-period time an and the half-period time bn, the correction signal generation unit 42 holds the amplitude of the correction signal Si at Xan by the sample-and-hold process. At the half-period time bn, the correction signal generation unit 42 switches the amplitude of the correction signal Si from Xan to Xbn. As described above, the correction signal generation unit 42 generates the correction signal Si by correcting the first upsampled signal Su1 based on the predicted value of the amplitude of the first upsampled signal Su1 at the next half-period time bn.

### Effects

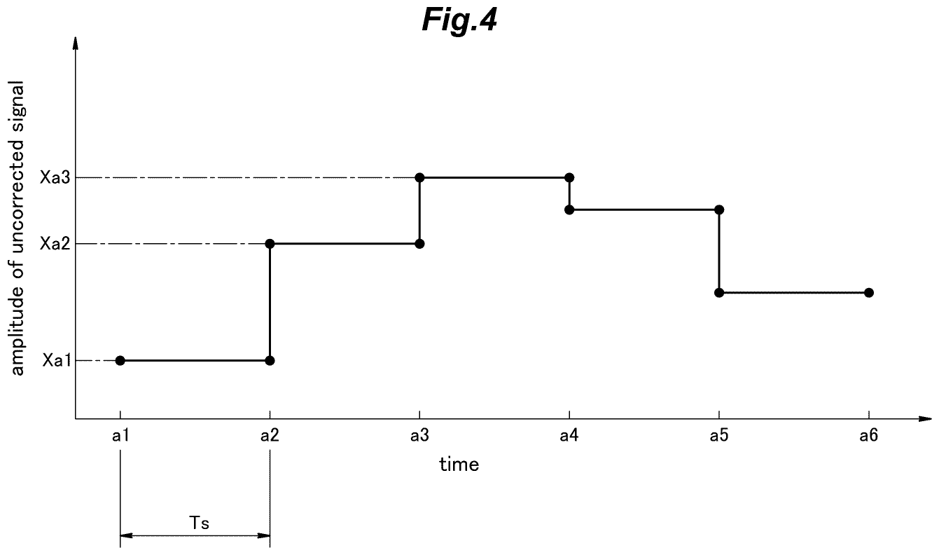

FIG. 4 is a waveform diagram showing the time variation of the amplitude of the signal that is not subjected to the above-mentioned correction (hereinafter referred to as the “uncorrected signal”). The amplitude of the uncorrected signal is held at Xan by the sample-and-hold process from the fundamental-period time an to the next fundamental-period time a(n+1). As is clear from a comparison between FIG. 3 and FIG. 4, the waveform of the correction signal Si is smoother than the waveform of the uncorrected signal. That is, the correction signal Si is smoother than the uncorrected signal.

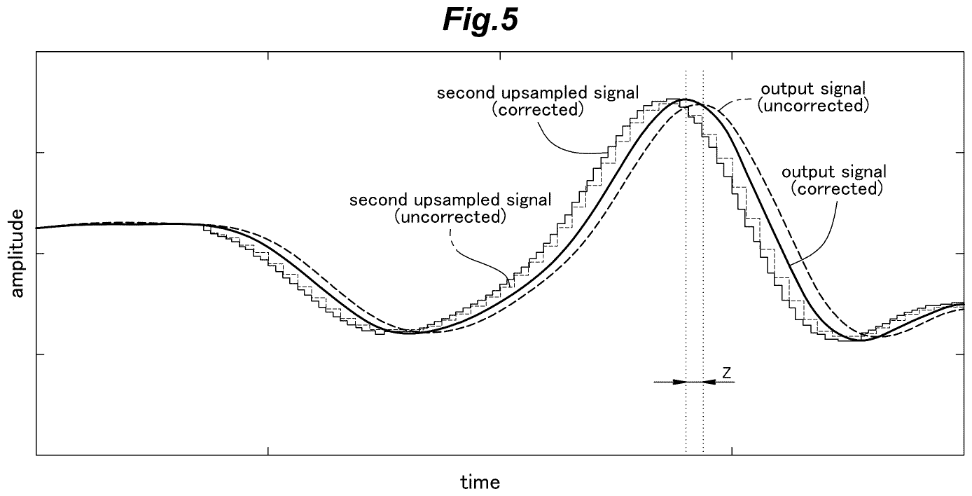

FIG. 5 is a waveform diagram showing the time variation of the amplitude of the second upsampled signal Su2 (the signal just before the low-pass filtering process) and the output signal So (the signal just after the low-pass filtering process). “Uncorrected” in FIG. 5 indicates that the first upsampled signal Su1 is not corrected based on the predicted value of the amplitude, and “corrected” in FIG. 5 indicates that the first upsampled signal Su1 is corrected based on the predicted value of the amplitude. When the first upsampled signal Su1 is corrected based on the predicted value of the amplitude, the smoothness of the second upsampled signal Su2 is improved, and the amount of calculation required for the low-pass filtering process is reduced as compared with a case where the first upsampled signal Su1 is not corrected based on the predicted value of the amplitude. Accordingly, when the first upsampled signal Su1 is corrected based on the predicted value of the amplitude, the delay of the output signal So is reduced by Z (ms) as compared with a case where the first upsampled signal Su1 is not corrected based on the predicted value of the amplitude.

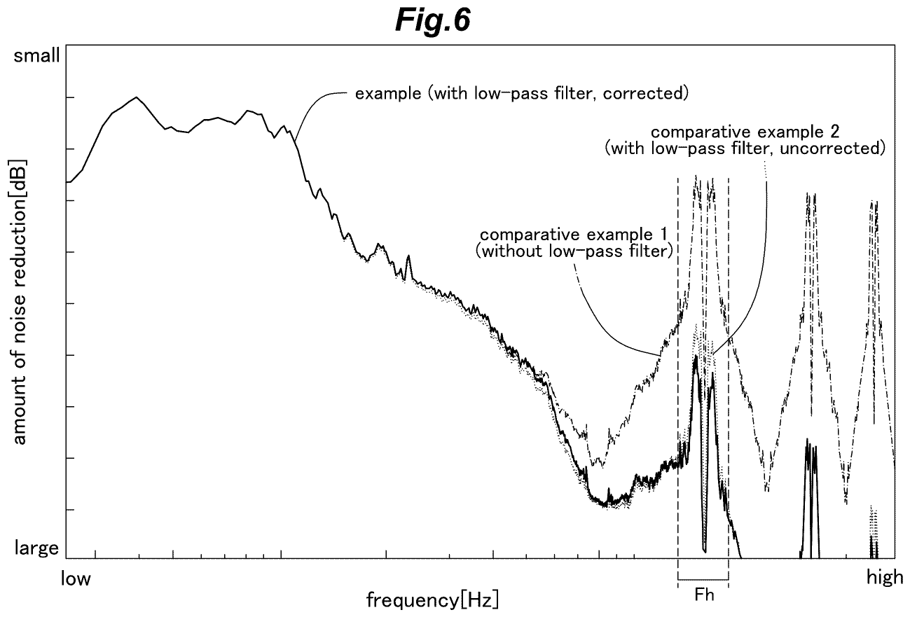

FIG. 6 is a waveform diagram showing the relationship between frequency and the amount of noise reduction in an example and comparative examples. “Without low-pass filter” in FIG. 6 indicates that the frequency converter 32 does not include the low-pass filter L, and “with low-pass filter” in FIG. 6 indicates that the frequency converter 32 includes the low-pass filter L. The contents of “uncorrected” and “corrected” in FIG. 6 are the same as those in FIG. 5, and therefore a description thereof is omitted. In this example (with low-pass filter, corrected), the amount of noise reduction is increased in the high frequency band Fh (an example of the frequency band targeted for noise reduction) compared to comparative example 1 (without low-pass filter) and comparative example 2 (with low-pass filter, uncorrected). This shows that high noise reduction performance can be achieved by performing the low-pass filtering process on the signal obtained by correcting the first upsampled signal Su1 based on the predicted value of the amplitude.

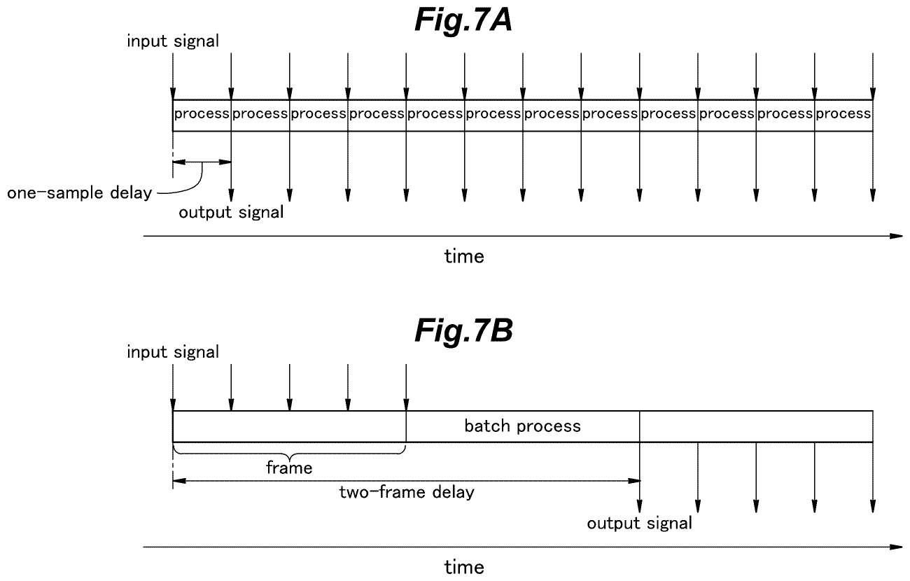

There are two types of signal processing methods: a sample-based process and a frame-based process. FIG. 7A is an explanatory diagram showing a flow of the sample-based process, and FIG. 7B is an explanatory diagram showing a flow of the frame-based process. With reference to FIG. 7A, in the sample-based process, the input signal is processed on a sample-by-sample basis to generate the output signal. Accordingly, the output signal is delayed by one sample relative to the input signal. With reference to FIG. 7B, in the frame-based process, a frame including the input signals for a plurality of samples is generated, and the input signals for the plurality of samples are batch-processed on a frame-by-frame basis to generate the output signal. Accordingly, the output signal is delayed by two frames relative to the input signal. Accordingly, the frame-based process increases the delay amount of the output signal relative to the input signal compared to the sample-based process.

Conventionally, the noise control device 1 and the audio control device 27 have been mounted on separate ECUs 21, with the sample-based process being used for the noise control device 1 and the frame-based process being used for the audio control device 27. In contrast, according to the present embodiment, since the noise control device 1 and the audio control device 27 are mounted on the same ECU 21, the signal processing method of the noise control device 1 and the signal processing method of the audio control device 27 need to be the same. Accordingly, the frame-based process is adopted not only for the audio control device 27 but also for the noise control device 1. Accordingly, the frequency converter 32 simultaneously converts the sampling frequency of the control signal u for a plurality of samples by the frame-based process (batch process) of the control signal u for a plurality of samples.

For the reasons mentioned above, if the frame-based process is adopted for the noise control device 1, there is a risk that the delay amount of the output signal So increases as compared with a case where the sample-based process is adopted. If the delay amount of the output signal So increases, the responsiveness of the canceling sound y to the noise d may decrease, resulting in a decrease in the noise reduction performance.

Accordingly, the frequency converter 32 generates the correction signal Si by correcting the first upsampled signal Su1 based on the predicted value of the first upsampled signal Su1. This improves the smoothness of the correction signal Si and reduces the amount of calculation required for the low-pass filtering process. Accordingly, even when the frame-based process is adopted for the noise control device 1, the delay amount of the output signal So can be reduced, and high noise reduction performance can be achieved.

### Modified Embodiment

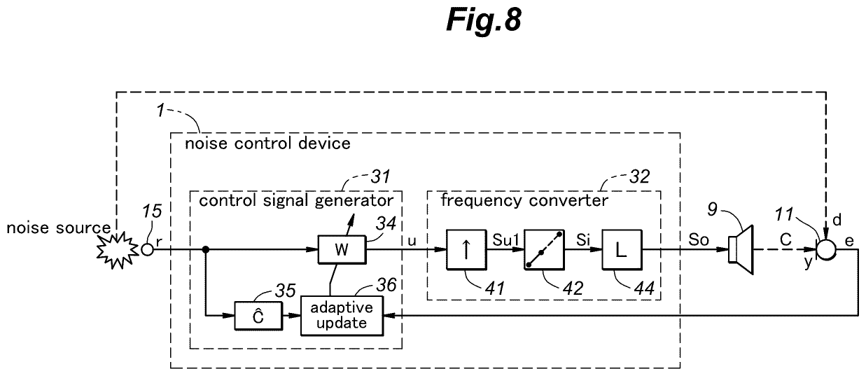

In the above embodiment, the filtering processing unit 44 generates the output signal So by performing the low-pass filtering process on the second upsampled signal Su2 (an example of the signal based on the correction signal Si). With reference to FIG. 8, according to another embodiment, the filtering processing unit 44 may generate the output signal So by performing the low-pass filtering process on the correction signal Si itself. That is, according to another embodiment, the second upsampling unit 43 may be omitted.

In the above embodiment, the increase ratio of the sampling frequency of the second upsampled signal Su2 to the sampling frequency of the correction signal Si is higher than the increase ratio of the sampling frequency of the first upsampled signal Su1 to the sampling frequency of the control signal u. In another embodiment, the increase ratio of the sampling frequency of the second upsampled signal Su2 to the sampling frequency of the correction signal Si may be equal to or less than the increase ratio of the sampling frequency of the first upsampled signal Su1 to the sampling frequency of the control signal u. When the sampling frequency of the control signal u is Fu, the sampling frequency of the first upsampled signal Su1 is FSu1, and the sampling frequency of the second upsampled signal Su2 is FSu2, the following equations (1) to (3) hold.

$$Fu < FSu 1 < FSu 2 \qquad ( 1 )$$

$$FSu 1 = n \times Fu ( n = 1 , 2 , … ) \qquad ( 2 )$$

$$FSu 2 = m \times FSu 1 ( m = 1 , 2 , … ) \qquad ( 3 )$$

In the above embodiment, the noise control device 1 is applied to the vehicle cabin 5 of the vehicle 3. In another embodiment, the noise control device 1 may be applied to the interior space of a moving object other than the vehicle 3 (for example, a ship or an aircraft), or the noise control device 1 may be applied to the interior space of a fixed object (for example, a house).

This concludes the explanation of the specific embodiment, but the present invention is not limited to the above embodiment or modified embodiment, and can be widely modified and implemented.

### Summary of Embodiment

An active noise control device 1 for controlling output of a canceling sound y to cancel noise d, the active noise control device comprising: a control signal generator 31 configured to generate a control signal u based on an input signal r, e; and a frequency converter 32 configured to convert a sampling frequency of the control signal u to generate an output signal So of the canceling sound y, and the frequency converter 32 is configured to: generate a first upsampled signal Su1 by increasing the sampling frequency of the control signal u; generate a correction signal Si by correcting the first upsampled signal Su1 based on a predicted value of the first upsampled signal Su1; and generate the output signal So of the canceling sound y by performing a low-pass filtering process on the correction signal Si or a signal Su2 based on the correction signal Si.

According to this aspect, the frequency converter 32 can suppress noise by performing the low-pass filtering process on the extrapolated signal Si or the signal Su2 based on the extrapolated signal Si. Further, the frequency converter 32 generates the correction signal Si by correcting the first upsampled signal Su1 based on the predicted value of the first upsampled signal Su1. This improves the smoothness (waveform smoothness) of the correction signal Si and reduces the amount of calculation required for the low-pass filtering process. Accordingly, it is possible to reduce the delay amount (delay time) of the output signal So relative to the input signal r, e, and to improve the responsiveness of the canceling sound y to the noise d, thereby achieving high noise reduction performance. As described above, it is possible to simultaneously suppress noise and delay when the sampling frequency of the control signal u is converted.

The frequency converter 32 is configured to: generate a second upsampled signal Su2 by increasing a sampling frequency of the correction signal Si; and generate the output signal So of the canceling sound y by performing the low-pass filtering process on the second upsampled signal Su2.

According to the above aspect, the sampling frequency of the control signal u can be increased to the target value by performing two upsampling processes (processes that increase the sampling frequency). Accordingly, as compared with a case where the sampling frequency of the control signal u is increased to the target value by performing only one upsampling process, the sampling frequency of the first upsampled signal Su1 (the signal after the first upsampling process) can be lowered. Accordingly, it is possible to reduce the amount of calculation required for the generation process of the correction signal Si based on the first upsampled signal Su1, thereby further reducing the delay amount of the output signal So relative to the input signal r, e.

The frequency converter 32 is configured to: increase the sampling frequency of the control signal u by performing integer-multiple sampling-frequency conversion on the control signal u; and increase the sampling frequency of the correction signal Si by performing integer-multiple sampling-frequency conversion on the correction signal Si.

According to this aspect, by performing the integer-multiple sampling-frequency conversion in both of the two upsampling processes, it is possible to reduce the high frequency components included in the second upsampled signal Su2 (the signal after the second upsampling process) and to improve the smoothness of the second upsampled signal Su2. Accordingly, it is possible to further reduce the amount of calculation required for the low-pass filtering process based on the second upsampled signal Su2, thereby further reducing the delay amount of the output signal So relative to the input signal r, e.

The frequency converter 32 is configured to set an increase ratio of a sampling frequency of the second upsampled signal Su2 relative to the sampling frequency of the correction signal Si higher than an increase ratio of a sampling frequency of the first upsampled signal Su1 relative to the sampling frequency of the control signal u.

According to this aspect, the sampling frequency of the first upsampled signal Su1 can be further reduced. Accordingly, it is possible to further reduce the amount of calculation required for the generation process of the correction signal Si based on the first upsampled signal Su1, thereby further reducing the delay amount of the output signal So relative to the input signal r, e.

The frequency converter 32 is configured to generate the output signal So of the canceling sound y by performing the low-pass filtering process on the correction signal Si.

According to this aspect, the configuration of the active noise control device 1 can be simplified as compared with a case where the low-pass filtering process is performed on the signal obtained by performing the second upsampling process on the correction signal Si.

The frequency converter 32 is configured to: obtain a predicted value of an amplitude of the first upsampled signal Su1 based on a time variation of the amplitude of the first upsampled signal Su1; and generate the correction signal Si by correcting the first upsampled signal Su1 based on the predicted value of the amplitude of the first upsampled signal Su1.

According to this aspect, by correcting the first upsampled signal Su1 based on the predicted value of the amplitude of the first upsampled signal Su1, the smoothness of the correction signal Si can be improved. Accordingly, it is possible to further reduce the amount of calculation required for the low-pass filtering process, thereby further reducing the delay amount of the output signal So relative to the input signal r, e.

The frequency converter 32 is configured to: generate the first upsampled signal Su1 for each fundamental-period time an; and obtain the predicted value of the amplitude of the first upsampled signal Su1 at an intermediate time bn between a current fundamental-period time an and a next fundamental-period time a(n+1), based on the time variation of the amplitude of the first upsampled signal Su1 at the current fundamental-period time an relative to the amplitude of the first upsampled signal Su1 at a previous fundamental-period time a(n−1).

According to this aspect, the smoothness of the correction signal Si can be improved without excessively complicating the generation process of the correction signal Si. Accordingly, it is possible to reduce the amount of calculation required for the generation process of the correction signal Si, thereby further reducing the delay amount of the output signal So relative to the input signal r, e.

The frequency converter 32 is configured to simultaneously convert the sampling frequency of the control signal u for a plurality of samples by a batch process of the control signal u for the plurality of samples.

According to this aspect, by batch processing the control signal u for a plurality of samples, the processing efficiency of the control signal u can be improved as compared with a case where the control signal u is processed on a sample-by-sample basis.

The frequency converter 32 is configured to calculate the predicted value of the first upsampled signal Su1 by an extrapolation process based on the first upsampled signal Su1.

According to this aspect, it is possible to calculate the predicted value of the first upsampled signal Su1 with high accuracy.

1. An active noise control device for controlling output of a canceling sound to cancel noise, the active noise control device comprising:
a control signal generator configured to generate a control signal based on an input signal; and
a frequency converter configured to convert a sampling frequency of the control signal to generate an output signal of the canceling sound, wherein
the frequency converter is configured to:
generate a first upsampled signal by increasing the sampling frequency of the control signal;
generate a correction signal by correcting the first upsampled signal based on a predicted value of the first upsampled signal; and
generate the output signal of the canceling sound by performing a low-pass filtering process on the correction signal or a signal based thereon.

2. The active noise control device according to claim 1, wherein the frequency converter is configured to:
generate a second upsampled signal by increasing a sampling frequency of the correction signal; and
generate the output signal of the canceling sound by performing the low-pass filtering process on the second upsampled signal.

3. The active noise control device according to claim 2, wherein the frequency converter is configured to:
increase the sampling frequency of the control signal by performing integer-multiple sampling-frequency conversion on the control signal; and
increase the sampling frequency of the correction signal by performing integer-multiple sampling-frequency conversion on the correction signal.

4. The active noise control device according to claim 2, wherein the frequency converter is configured to set an increase ratio of a sampling frequency of the second upsampled signal relative to the sampling frequency of the correction signal higher than an increase ratio of a sampling frequency of the first upsampled signal relative to the sampling frequency of the control signal.

5. The active noise control device according to claim 1, wherein the frequency converter is configured to generate the output signal of the canceling sound by performing the low-pass filtering process on the correction signal.

6. The active noise control device according to claim 1, wherein the frequency converter is configured to:
obtain a predicted value of an amplitude of the first upsampled signal based on a time variation of the amplitude of the first upsampled signal; and
generate the correction signal by correcting the first upsampled signal based on the predicted value of the amplitude of the first upsampled signal.

7. The active noise control device according to claim 6, wherein the frequency converter is configured to:
generate the first upsampled signal for each fundamental-period time; and
obtain the predicted value of the amplitude of the first upsampled signal at an intermediate time between a current fundamental-period time and a next fundamental-period time, based on the time variation of the amplitude of the first upsampled signal at the current fundamental-period time relative to the amplitude of the first upsampled signal at a previous fundamental-period time.

8. The active noise control device according to claim 1, wherein the frequency converter is configured to simultaneously convert the sampling frequency of the control signal for a plurality of samples by a batch process of the control signal for the plurality of samples.

9. The active noise control device according to claim 1, wherein the frequency converter is configured to calculate the predicted value of the first upsampled signal by an extrapolation process based on the first upsampled signal.
